(19) United States
(12) Patent Application Publication
(10) Pub. No.: US 2004/0129917 A1
(43) Pub. Date: Jul. 8, 2004

(54) Composition for forming piezoelectric film, manufacturing method of piezoelectric film, piezoelectric element and ink jet recording head

(75) Inventors: Makoto Kubota, Kanagawa (JP); Motokazu Kobayashi, Kanagawa (JP); Hisao Suzuki, Aichi (JP); Fumio Uchida, Osaka (JP); Chiemi Shimizu, Osaka (JP); Kenji Maeda, Gifu (JP)

Correspondence Address: FITZPATRICK CELLA HARPER & SCINTO, 30 ROCKEFELLER PLAZA, NEW YORK, NY, 10112, US

(73) Assignees: Canon Kabushiki Kaisha, Tokyo (JP); Fuji Chemical Co. Ltd., Osaka (JP)

(21) Appl. No.: 10/665,429

(22) Filed: Sep. 22, 2003

(30) Foreign Application Priority Data
Sep. 20, 2002 (JP) 2002-275751(PAT.)

(51) Int. Cl. C04B 35/00; B05D 5/12

(52) U.S. Cl. 252/62.9 R; 252/62.9 PZ; 106/287.19; 427/100

(57) ABSTRACT

A composition for forming piezoelectric film comprising a dispersoid obtained from a metal compound, wherein the total content of the elemental halogens, halogen ions and halogen compounds contained in the composition is 10 ppm or less.

### BACKGROUND OF THE INVENTION

1. Field of the Invention

The present invention relates to a composition for forming piezoelectric film, a manufacturing method of piezoelectric film by use of the composition, a piezoelectric element utilizing the piezoelectric film and an ink jet recording head.

2. Related Background Art

A piezoelectric film, as represented by a lead titanate zirconate (PZT) film, is utilized as a piezoelectric element for an ink jet recording head. In any type of film formation, it is necessary to accelerate the crystallization of the film by a final thermal treatment, for the purpose of forming a ferroelectric film used in this use and making the film display a sufficient electromechanical function (a pressure inducing displacement). Additionally, in order to attain a sufficient displacement as an element, a film thickness of the order of 1 μm to 25 μm is required.

Usually, a PZT film can be formed by the screen printing method, sputtering method, sol-gel method, CVD method, hydrothermal method and the like; an annealing is usually conducted at 700° C. or above in order to obtain a perovskite structure crystal provided with piezoelectricity. In order to increase the film thickness, the deposition time for film formation is elongated, or the film formation operations is repeated in a plurality of times. Among the above described film formation methods, the sol-gel method is excellent in composition regulation in such a way that the repeated sets of application and baking permit an easy formation of a thin film. Additionally, a film obtained by the sol-gel method is so high in density that the pressure inducing displacement is not dispersed and hence the film is expected to exhibit satisfactory piezoelectricity.

The sol-gel method is the one in which a sol containing the hydrolyzable compound of each metal component to be used as a raw material, the partially hydrolyzed product thereof, or the partial polycondensation product thereof is applied onto a substrate, the coating film thus obtained is dried, then heated in the air to form a metal oxide film and additionally baked at the crystallization temperature of the metal oxide or above to crystallize the film, and thus a metal oxide thin film is formed. As the hydrolyzable metal oxide as the raw material, generally used are such organic compounds as metal alkoxides, partially hydrolyzed products thereof or partial polycondensation products thereof. The sol-gel method permits forming a ferroelectric thin film in a most inexpensive and convenient manner.

As a method similar to the sol-gel method, here can be cited the metal-organic decomposition method (MOD method). The MOD method is the one in which a solution containing a heat decomposable organometallic compound, such as a metal β-diketone complex or a metal carboxylate is applied onto a substrate, the substrate is heated, for example, in the air or in oxygen to evaporate the solvent in the coating film and to thermally decompose the metal compound, thus a film of the metal oxide is formed, and additionally baking is conducted at the crystallization temperature or above to crystallize the film. The “sol-gel method” as referred to in the present invention includes the sol-gel method, the MOD method and a combination of these methods. Additionally, “the composition for use in forming piezoelectric film” as referred to in the present specification includes the coating solution such as a sol for use in forming piezoelectric film by the sol-gel method and a raw solution composition in a stage earlier than the sol formation.

Additionally, an ink jet printer head has been disclosed in which a piezoelectric element formed as a film by use of the sol-gel method is used. For example, a method of forming a piezoelectric film of a piezoelectric element used in an ink jet printer head has been disclosed in which by utilizing the sol-gel method a sol containing a piezoelectric material is applied onto a lower electrode in a manner divided into a plurality of times and the heating treatment is repeated at each time of application (see, for example, Japanese Patent Application Laid-Open Nos. H9-92897, H10-139594 and H10-290035).

Additionally, well known to those skilled in the art is a method, as a representative example, for forming piezoelectric film by use of a hydrolyzable or a heat decomposable organometallic compound such as the alkoxide of the component metal or a raw material containing the hydorxide of the component metal (hereinafter referred to as sol) (for example, Japanese Patent Application Laid-Open No. 60-236404).

### SUMMARY OF THE INVENTION

When annealing is made in order to obtain a crystal of perovskite structure having piezoelectricity by means of the sol-gel method, there occurs a problem that impurities are deposited on the grain boundary of the growing crystal grains and accordingly the leak current is increased. This problem may be solved by purifying, to a high purity, the raw material contained in the composition solution, but it is not known which impurity contained in the composition solution is to be decreased in quantity to any extent for the purpose of efficiently suppressing the leak current.

The present inventors have paid attention to some highly conductive components deposited after annealing and repeated various analysis experiments for the components, and consequently have found that elemental halogens, halogen ions and halogen compounds are the main causal components. The present invention takes as its main object the provision of a piezoelectric film extremely low in leak current produced by the sol-gel method, a composition for forming the piezoelectric film and a manufacturing method of the piezoelectric film. Additionally, another object of the present invention is to provide a piezoelectric element and an ink jet recording head wherein the above described piezoelectric film is comprised.

For the purpose of overcoming the above described problems, the present inventors have attempted to attain highly purified raw materials needed for production of the composition for forming the piezoelectric film, and have investigated the relation between the total content (hereinafter referred to as the halogen content) of the elemental halogens, halogen ions and halogen compounds contained in the produced composite solution and the leak current value. Consequently, the present inventors came to achieve the present invention by discovering that the leak current is sharply reduced when the halogen content is 10 ppm or less, preferably 3 ppm or less. The present invention relates to a composition for forming piezoelectric film containing a dispersoid obtained from a metal compound, wherein the halogen content in the composition is 10 ppm or less.

The present invention additionally prefers that the metal compound be an organometallic compound. The present invention additionally prefers that the halogen content contained in the composition for forming piezoelectric film be 3 ppm or less. The present invention additionally prefers that at least titanium, zirconium and lead be comprised as metals. The present invention additionally relates to a manufacturing method of a piezoelectric film wherein the formation method of the piezoelectric film comprises a process for forming a coating film by applying the above described composition for forming piezoelectric film onto a substrate, a process for drying the coating film, and a process for baking the dried coating film to yield a piezoelectric film.

The present invention additionally relates to a piezoelectric element provided with a piezoelectric film sandwiched between a lower electrode and an upper electrode wherein the piezoelectric film is produced by the above described method. The present invention additionally relates to an ink jet recording head which comprises an ink jet orifice, a pressure chamber communicating with the ink jet orifice, a vibrating plate constituting a part of the pressure chamber, and a piezoelectric element imparting vibration to the vibrating plate arranged outside the pressure chamber, and jets the ink inside the pressure chamber from the ink jet orifice by the volume change inside the pressure chamber generated by the vibration imparted to the vibrating plate, wherein the piezoelectric element is the above described piezoelectric element.

According to the present invention, a composition for forming piezoelectric film is provided in which the halogen content is 10 ppm or less, preferably 3 ppm or less. Additionally, according to the present invention, a composition for forming piezoelectric film is provided in which at least titanium, zirconium and lead are contained, and the halogen content is 10 ppm or less, preferably 3 ppm or less.

Additionally, according to the present invention, a piezoelectric film which is extremely small in leak current can be obtained by use of the composition for forming a piezoelectric film. From the piezoelectric film, a PZT piezoelectric element having excellent piezpoelectricity can also be produced, which can be applied to various uses including, for example, a piezo head for an ink jet recording device.

### BRIEF DESCRIPTION OF THE DRAWINGS

FIG. 1 is a schematic longitudinal sectional view showing an example of embodiment of the piezoelectric element of the present invention wherein enlarged is a part of the piezoelectric element sandwiched between a lower electrode and an upper electrode both on a substrate;

FIG. 2 is a schematic longitudinal sectional view showing an example of embodiment of the piezoelectric element of the present invention wherein enlarged is a part of an ink jet recording head in which a piezoelectric element is used as the actuator;

FIG. 3 is a schematic oblique perspective view showing an example of the form of a substrate used in Example 5 of the present invention, wherein enlarged is a zirconia substrate which is designed to permit observation of the vibrational behavior of the piezoelectric film through a thin portion formed by boring;

FIG. 4 is a schematic longitudinal sectional view showing an example of the form of a substrate used in Example 5 of the present invention, wherein enlarged is a zirconia substrate which is designed to permit observation of the vibrational behavior of the piezoelectric film through a thin portion formed by boring;

FIG. 5 is a schematic longitudinal sectional view showing an example of the form of an ink jet recording head produced in Example 7 of the present invention, wherein enlarged is a part of the ink jet recording head in which a nozzle is arranged below the piezoelectric element obtained in Example 5 and an ink introduction tube is arranged so that the ink jetting experiment can be conducted; and

FIG. 6 is a schematic oblique perspective view showing an example of the form of an ink jet recording head produced in Example 7 of the present invention, wherein enlarged is a part of the ink jet recording head in which a nozzle is arranged below the piezoelectric element obtained in Example 5 and an ink introduction tube is arranged so that the ink jetting experiment can be conducted.

### DESCRIPTION OF THE PREFERRED EMBODIMENTS

In a composition for forming an piezoelectric film containing a dispersoid obtained from a metal compound, the halogen content contained in the composition is required to be 100 ppm or less. When for film formation a composition is used in which the halogen content exceeds 10 ppm because of insufficient purification of the raw material both before the composition production and in the course of the composition production, the impurities deposit on the grain boundary of the crystal grains at the time of annealing, and accordingly the leak current is increased, and the piezoelectricity and ferroelectricity of the film are remarkably degraded. Preferably, it is recommended that the halogen content in the composition for forming a piezoelectric film is 3 ppm or less.

Incidentally, the measurement method of the halogen content in a composition for forming a piezoelectric film includes the ion chromatography, emission spectrometry utilizing the inductively coupled high frequency plasma (ICP emission spectrometry), atomic absorption spectrometry, silver nitrate titration method, quantitative analysis utilizing selective electrodes, and combinations thereof.

The types of metals composing the metal compounds contained in a composition for forming piezoelectric film are selected so that the metal compounds may form a combination with which the metal compounds yield those metal oxides that have piezoelectricity after the film formation based on the sol-gel method. Preferably, it is recommended that the metal types include at least titanium, zirconium and lead. Additionally, it is preferable that as the metallic species, titanium is contained in 15 to 40 atom %, zirconium is contained in 15 to 40 atom % and lead is contained in 40 to 70 atom % in relation to the total metal content in the metal compounds. More preferably, it is recommended that titanium is contained in 18 to 25 atom %, zirconium is contained in 20 to 28 atom % and lead is contained in 45 to 65 atom % in relation to the total amount of the metal atoms in the metal compounds. By incorporating titanium in 18 to 25 atom %, zirconium in 20 to 28 atom % and lead in 45 to 65 atom % in relation to the total amount of the metal atoms in the metal compounds, a piezoelectric substance having a high dielectric constant, and excellent ferroelectricity and excellent optical properties can be obtained.

The metal compound having piezoelectricity includes barium titanate (BTO), lead titanate (PT), lead titanate zirconate (PZT), lanthanum doped lead titanate zirconate (PLZT), and a solid solution in which lead magnesium niobate (PMN) is added as a third component. Additionally, these metal oxides can contain a trace amount of dope elements. Examples of the dope elements include Ca, Sr, Ba, Hf, Sn, Th, Y, Sm, Dy, Ce, Bi, Sb, Nb, Ta, W, Mo, Cr, Co, Ni, Fe, Cu, Si, Ge, U and Sc. The content of the dope elements is 0.05 or less in the atomic fraction of the metal atoms in the above described general formula. Incidentally, the above described elements can be doped by adding appropriate amounts of the compounds containing the relevant elements.

Among the piezoelectric substances that can be produced by the present invention, those metal oxides having the compositions represented by the general formula, Pb₁₋ₓLaₓ(Zr_{y}Ti_{1-y})O₃ (0≦x≦1, 0≦y≦1) such as lead titanate zironate (PZT) and lanthanum doped lead titanate zirconate (PLZT) are the piezoelectric substances having the perovskite type crystal structure; these piezoelectric compounds are high in dielectric constant, and excellent in ferroelectricity and optical properties so that the films of these compounds have already been used in capacitor films, photosensors, optical circuit elements and the like, and additionally are expected to be used in new applications including nonvolatile memory.

The method of producing such piezoelectric films, on the basis of the sol-gel method by use of a composition for forming piezoelectric film containing organometallic compounds of the component metals such as represented by hydrolyzable or heat decomposable alkoxides and the like, is well known to those skilled in the art. The present invention is characterized in that the halogen content in the composition for forming piezoelectric film is 10 ppm or less, preferably 3 ppm or less, and except for this characteristic, the composition and the film formation method may generally be the same as the conventional sol-gel method and the like.

In order to obtain such a high purity composition, it is necessary to select raw materials which do not contain halogen compounds and to conduct beforehand the sufficient purification operation for removing the elemental halogens, halogen ions and halogen compounds contained as impurities. The purification method may vary depending on the form and characteristics of the raw material; distillation can be applied if the raw material is a liquid composition such as a solvent, sublimation can be applied for a solid raw material, the solvent replacement by use of a high purity solvent having been distilled and the use of ion exchange resin can be applied for a solution raw material. In order to attain the purity required in the present invention, it is preferable to repeat these purification methods a plurality of times or to combine these methods. Additionally, a trace amount of halides in the raw material, in particular, in the solvent become high in concentration in the concentration process involved in the composition production process, and hence it is preferable to conduct appropriately a purification process such as ion exchange treatment not only before blending but also in some intermediate stages. The raw material from which halides are removed by purification is used for the composition for forming piezoelectric film. Those raw materials which contain halides as the constituent components are not utilized.

Those metal compounds which are preferable as the raw material are hydrolyzable or heat decomposable organometallic compounds. Representative examples of such compounds include organometallic alkoxides, metal salts of organic acids, and metal complexes such as β-diketone complexes; as for the metal complexes, other various complexes including amine complexes can be used. The β-diketone includes acetyl acetone (=2,4-pentanedione), heptafluorobutanoylpivaloylmethane, dipivalolylmethane, trifluoroacetyl acetone and benzoyl acetone.

Specific examples of the preferred organometallic compounds include lead compounds and lanthanum compounds such as organic acid salts represented by acetates (lead acetate, lanthanum acetate) and organometallic alkoxides such as diisopropoxylead. Preferred titanium compounds include organometallic alkoxides such as tetraethoxytitanium, tetraisopropoxytitanium, tetra-n-butoxytitanium, tetra-i-butoxytitanium, tetra-t-butoxytitanium and dimethoxydiisopropoxytitanium; organic acid salts and organometallic complexes of titanium can also be used. Zirconium compounds similar to the above described titanium compounds are preferable. Preferred compounds of other metals are similar to the above described compounds, but not limited to the above described compounds. Additionally, the above described compounds may be used as combinations thereof.

In addition to those above described compounds which contain one type of metal, composite organometallic compounds containing two or more types of metals as components may be used as raw materials. Examples of such composite organometallic compounds include PbO₂[Ti(OC₃H₇)₃]₂ and PbO₂[Zr(OC₄H₉)₃]₂.

The organometallic compounds used as the metal component raw materials are dispersed together in an appropriate solvent after halides have been fully removed therefrom by means of the operations including distillation and recrystallization, to prepare the composition for forming piezoelectric film containing the precursor of a composite organometallic oxide (an oxide containing two or more types of metals) which is the raw material for a piezoelectric substance. In this case, the solvent used for the composition is the one from which halides have been fully removed beforehand. Additionally, the solvent is selected from the various solvents well known in the art in view of the dispersibility and coatability; those solvents which contain halogens in the constitution thereof are inappropriate.

Examples of the solvent include alcoholic solvents such as methanol, ethanol, n-butanol, n-propanol and isopropanol; ethereal solvents such as tetrahydrofuran and 1,4-dioxane; cellosolve solvents such as methyl cellosolve and ethyl cellosolve; amide solvents such as N,N-dimethylformamide, N,N-dimethylacetamide and N-methylpyrrolidone; and nitrile solvents such as acetonitrile. Among these solvents, alcoholic solvents are preferable. The amount of the solvent used in the sol-gel method in the present invention is from 5 times in mole ratio to 200 times in mole ratio, preferably from 10 times in mole ratio to 100 times in mole ratio in relation to the amount of the organometallic alkoxide. In the case where metal complexes are used, the amount of the solvent is from 5 times in mole ratio to 200 times in mole ratio, preferably 10 times in mole ratio to 100 times in mole ratio, in relation to the amount of the metal complexes. Additionally, in the case where metal salts of organic acids are used, the amount of the solvent is from 5 times in mole ratio to 200 times in mole, preferably from 10 times in mole ratio to 100 times in mole ratio, in relation to the amount of the metal salts of organic acids. The solvent amount, set at 5 times in mole ratio to 200 times in mole ratio in relation to the amount of the organometallic alkoxides, set at 5 times in mole ratio to 200 times in mole ratio in relation to the amount of the metal complexes, or set at 5 times in mole ratio to 200 times in mole ratio in relation to the amount of the organometallic alkoxides, makes it possible to easily cause gelation and leads to a moderate exothermic heat at the time of hydrolysis.

The ratios of the individual organometallic compounds made to be contained in the composition for forming piezoelectric film may be nearly the same as the composition ratios in the piezoelectric film to be formed. Incidentally, a lead compound is generally high in volatility, and hence sometimes the deficiency in the lead content ascribable to the evaporation of lead occurs during heating for transforming into metal oxides or during baking for crystallization. Accordingly, under anticipation of this possible deficiency in the lead content, the lead content may be set at a slightly excessive amount (for example, in excess of 2 to 20 mass %). The degree of deficiency in the lead content depends on the types of the lead compounds and the conditions for film formation, and can be evaluated experimentally.

A composition solution in which metal compounds are dispersed in an organic solvent may be used as it is as the composition for forming piezoelectric of the present invention in the film formation by means of the sol-gel method if the halogen content is 10 ppm or less, preferably 3 ppm or less. On the other hand, in order to accelerate the film formation, the sol is added with water and/or heat to partially hydrolyze the hydrolyzable organometallic compounds (for example, organometallic alkoxides) or to conduct partial polycondensation, and then may be used for film formation as the composition for forming piezoelectric film of the present invention. In other words, in this case, as far as at least a part of the organometallic compounds are concerned, the composition comes to contain the partially hydrolyzed products and/or partial polycondensation products thereof.

The heating for the purpose of partial hydrolysis is conducted under controlling the temperature and time so that the hydrolysis may not proceed to a full extent. The partial hydrolysis imparts stability to the composition so that the composition comes to hardly gelate and uniform film formation becomes possible. The appropriate heating conditions are such that the temperature falls within the range from 80 to 200° C. and the time duration falls within the range from 0.5 to 50 hours. During hydrolysis, sometimes the hydrolyzed products are subjected to the partial polycondensation ascribable to the —M—O— bonding (M=metal). Such polycondesation is acceptable as far as it is of partial extent.

The composition for forming piezoelectric film may contain a small amount of stabilizing agent; it is necessary to purify beforehand the stabilizing agent by means of distillation, reprecipitation and the like to remove the halides. The addition of the stabilizing agent serves to suppress the hydrolysis rate and polycondensation rate of the composition, and hence the stability of the composition is improved. Examples of the compounds useful as the stabilizing agent include β-diketones (for example, acetylacetone, dipivaloylmethane, benzoylacetone and the like); ketonic acids (for example, acetoacetic acid, propionylacetic acid, benzoylacetic acid and the like); lower alkyl esters of these ketonic acids including methyl, propyl and butyl ones; oxy acids (for example, lactic acid, glycolic acid, α-oxybutyric acid, salicylic acid and the like); lower alkyl esters of these oxy acids; oxy ketones (for example, diacetone alcohol, acetoin and the like); α-amino acids (for example, glycine, alanine and the like); and alkanolamines (for example, diethanolamine, triethanolamine, monoethanolamine and the like).

The concentrations of the metal compounds contained in the composition for forming piezoelectric film are not particularly limited, varied depending on the coating method adopted and whether the partial hydrolysis is conducted or not, and preferably falls within the range from 0.1 to 35 mass % as converted to the concentrations of the corresponding metal oxides. In this connection, the addition of a stabilizing agent serves to suppress the hydrolysis rate and the polycondensation rate of the composition, and thus the preservation stability of the composition is improved. Examples of the stabilizing agent include β-diketones, α-oxybutyric acid and benzoylacetic acid. Additionally, according to need, various additives well known in the art such as polymerization accelerators, antioxidants, UV absorbing agents, dyes, pigments and the like can be appropriately blended in the composition after purification.

Additionally, a compound having binder effect may be added to the composition for forming piezoelectric film of the present invention for the purpose of thickening the film thickness at the time of coating. As the binder compound, compounds containing no halogens in the constitution thereof are selected. Examples of the binder compound include cellulose derivatives such as ethyl cellulose and hydroxypropyl cellulose; polymer resins such as polyvinyl alcohol, polyvinylpyrrolidone and polyvinylpyrrolidone derivatives; and rosin and rosin derivatives. When hydroxypropyl cellulose is used, the weight average molecular weight thereof is preferably 10,000 or more and 200,000 or less. The weight average molecular weight made to be 10,000 or more and 200,000 or less makes it possible to exhibit the binder effect for thickening the film at the time of coating without leading to high viscosity. More preferably, the weight average molecular weight of hydroxypropyl cellulose is recommended to be 20,000 or more and 100,000 or less.

The use of the composition for forming piezoelectric film of the present invention permit film formation of piezoelectric films lower in leak current as compared to films produced by the conventional sol-gel method, for example, barium titanate (BTO) film, lead titanate (PT) film and lead titanate zirconate (PZT) film. These films are extremely low in energy loss caused by current leak, and hence are expected to exhibit excellent ferroelectricity and excellent electromechanical transduction function.

Detailed description will be made below on the method of film formation in which the composition for forming piezoelectric film of the present invention is used. The substrate for the piezoelectric film to be formed thereon can be selected from metals, glass, ceramics and the like according to the intended purpose, and may be a substrate made of silicone wafer and the like. The substrate may be subjected to appropriate surface treatment beforehand. For example, surface treatment may be conducted by use of a silane coupling agent and an appropriate surface treating agent. Additionally, a metallic layer made of titanium, platinum, palladium, iridium and the like may be arranged on the substrate surface.

The coating method is not particularly limited, and coating is conducted by means of conventional coating methods including the spin coating method, cast method, spray coating method, doctor blade method, die coating method, dipping method and printing method. Among these methods, the preferable methods are the spin coating method, cast method, spray coating method, doctor blade method and die coating method. A dried coating layer can be formed by removing the solvent through drying after coating. The temperature for this treatment is varied depending on the solvent used, and in general preferably 100° C. to 450° C. When a thick film is required, the set of coating and drying is repeated.

A dried coating layer obtained by repeating the set of coating and drying as many times as necessary is subjected to heating for conducting the baking process. The baking conditions are varied depending on the type of the composition for forming piezoelectric film, the use of the film and the like. It is preferable that the baking temperature is not lower than the crystallization temperature of the composition for forming piezoelectric film. For example, in the case of such a ferroelectric film as made of lead titanate zirconate (PZT) or lanthanum doped lead titanate zirconate (PLZT), the baking can be conducted at a temperature of the order of 400 to 1,400° C., preferably of the order of 550 to 800° C. Additionally, the baking can be conducted in an optional environment including an inert gas environment, a steam environment and an oxygen containing environment (the air), and under atmospheric pressure, an elevated pressure or a reduced pressure. The total content of the elemental halogens, halogen ions and halogen compounds in the piezoelectric film obtained consequently is 10 ppm or less, preferably 3 ppm or less.

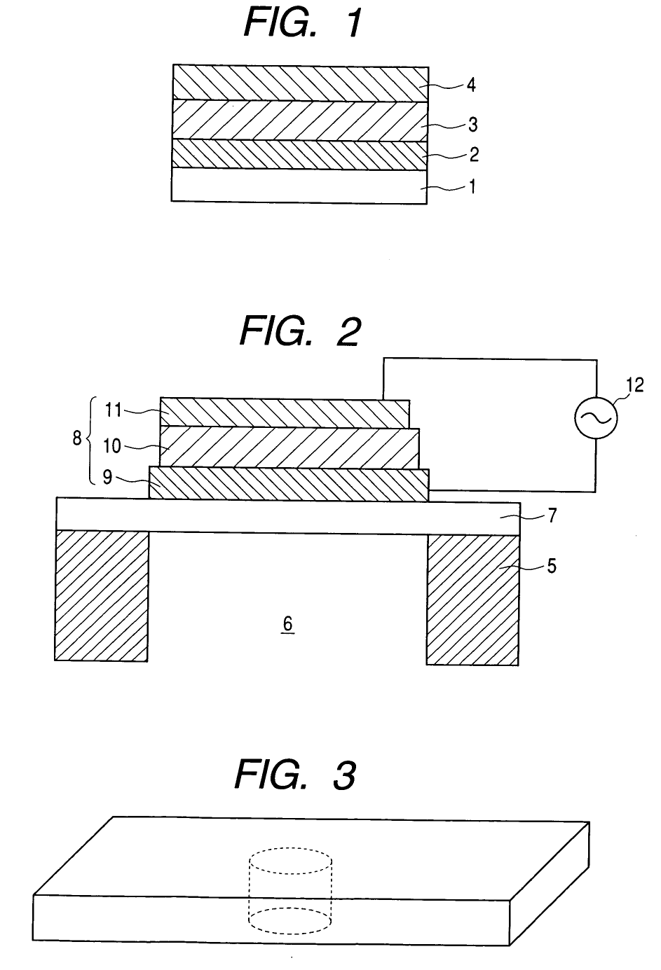

The use of the perovskite type piezoelectric film according to the present invention includes a piezoelectric element formed by sandwiching with electrodes. The piezoelectric film formed by use of the composition for forming piezoelectric film and the film formation method of the present invention is small in leak current, and accordingly deformed owing to the piezoelectric effect when an appropriate voltage is applied. Additionally, the adoption of the sol-gel method as the film formation method easily permits fine regulation of the size and shape of the piezoelectric element. Thus, on the basis of easy operations, the present invention permits production of, for example, a piezoelectric element with fine patterns having a resolution of 80 μm and an aspect ratio of 3. Now, description will be made below on a preferred embodiment as an application of the present invention with reference to FIG. 1.

FIG. 1 is a view showing the configuration of one embodiment of the piezoelectric element of the present invention. In FIG. 1, reference numeral 1 denotes a substrate. The substrate material can be selected, according to the intended purpose, from metals, glass, ceramics and the like, and the substrate may be a silicon wafer substrate and the like. The substrate may be beforehand subjected to an appropriate surface treatment. For example, the surface treatment may be conducted by use of a silane coupling agent and an appropriate surface treatment agent. The piezoelectric element has a structure in which a piezoelectric film 3 is formed on the surface of a lower electrode 2, an upper electrode 4 is formed on the surface of the piezoelectric film, and thus the piezoelectric film 3 is sandwiched between the lower electrode 2 and the upper electrode 4. The materials for the lower electrode 2 and the upper electrode 4 are not particularly limited, and can be those materials which are usually used for the piezoelectric element, including for example platinum and gold. Additionally, the materials for the lower electrode 2 and the upper electrode 4 can be either the same or different from each other. The thicknesses of these electrodes are not particularly limited, and are preferably for example 0.03 μm to 2 μm, more preferably 0.05 μm to 0.75 μm.

As an application of the above described piezoelectric element, an ink jet recording head can be cited. Description will be made below on the preferred embodiment of this application with reference to FIG. 2. FIG. 2 is a schematic enlarged longitudinal sectional view showing a part of an ink jet recording head in which the piezoelectric element according to the present invention is used as the actuator. The configuration of the recording head is similar to the conventional one, and is composed of a head base 5, a vibrating plate 7, and an actuator composed of a piezoelectric element 8 and a power supply 12. The piezoelectric element 8 has a structure in which a piezoelectric film 10 is formed on the surface of a lower electrode 9, an upper electrode 11 is formed on the surface of the piezoelectric film 10, and thus the piezoelectric film 10 is sandwiched between the lower electrode 9 and the upper electrode 11.

A large number of ink nozzles (not shown in the figure) for jetting ink, a large number of ink paths (not shown in the figure) each communicating with any one of the nozzles and a large number of ink chambers 6 as the pressure chambers each communicating in a one-to-one correspondence with one of the ink paths are formed in the head base 5; the vibrating plate 7 is fixed on the head base 5 in a manner covering all the upper surface thereof, and the vibrating plate 7 blocks the upper face openings of all the ink chambers 6 in the head base 5. The piezoelectric elements 8 to give driving force to the vibrating plate 7 are formed on the vibrating plate 7 at the positions each in one-to-one correspondence to one of the ink chambers 6. By applying voltage to a desired and selected piezoelectric element 8 by use of the power supply 12 in the actuator, the piezoelectric element 8 is deformed and the corresponding part of the vibrating plate 7 is made to vibrate. Accordingly, the volume of the ink chamber 6, involving the part of the vibrating plate 7 corresponding to the vibration, is varied and hence ink is made to pass through the ink path and pushed out from an ink nozzle, thus printing being made.

The piezoelectric film 10 is formed either with the PZT represented by the chemical formula, Pb(Zr₁₋ₓTiₓ)O₃(0.3≦x≦0.9, preferably 0.4≦x≦0.9), or with the PZT as the main component. The thickness of the piezoelectric film is preferably 0.2 μm to 25 μm, more preferably 0.5 μm to 10 μm. The film thickness ranging from 0.2 μm to 25 μm permits generating sufficient displacement of the piezoelectric element 8 with a moderate voltage.

Additionally, the piezoelectric film 10 has been formed by use of the composition for forming piezoelectric film by means of the ferroelectric film formation method of the present invention. More specific description will be made below on the present invention on the basis of examples, but the present invention is not limited by the examples.

### EXAMPLES

(Purification of the Raw Materials used in the Composition for Forming Piezoelectric Film)

In the preparation of the composition for forming piezoelectric film of the present invention, the raw materials listed in the following table were used which were obtained from the commercially available laboratory reagents through purification as specified in the table.

TABLE 1

| | | | | Ion |
|---|---|---|---|---|
| | | Recrystalli- | Solvent | exchange |
| Raw material | Distillation | zation | replacement | resin |
| 2- | 4 Times | — | — | — |
| Methoxyethanol | | | | |
| Lead acetate | 1 Time | 2 Times | — | — |
| trihydrate | | | | |
| Tetraisopropoxy | 2 Times | — | 3 Times | — |
| titanium | | | | |
| Tetra-n-butoxy | 2 Times | — | 3 Times | — |
| zirconium | | | | |
| Diethoxy barium | 1 Time | 2 Times | — | — |
| Acetylacetone | 4 Times | — | — | — |
| Water | 1 Time | — | — | 3 Times |

### Preparation example 1 of a High Purity Composition for Forming Piezoelectric Film: Composition for Forming PZT Piezoelectric Film

All the reagents as raw materials were, before used, subjected to sufficient removal of halogen components by means of the above described purification method. In 2-methoxyethanol 0.115 mol of lead acetate trihydrate was dispersed and the water contained therein was removed by the azeotropic distillation together with the solvent. The solution was added with 0.048 mol of tetraisopropoxy titanium and 0.052 mol of tetra-n-butoxy zirconium, refluxed, further added with 0.25 mol of acetylacetone (a stabilizing agent), and stirred sufficiently. Then, the solution was added with 0.5 mol of water, and the concentration thereof was adjusted with 2-methodyethanol to prepare a lead titanate zirconate (PZT) composition for forming piezoelectric film in which the concentration of lead titanate zirconate was 10 mass % as converted to the corresponding oxide. This will be referred to as the composition A for use in formation of piezoelectric film. The halogen content in the composition A for use in formation of piezoelectric film was below the analytical detection limit; thus, the halogen content was derived from the halogen contents of the raw materials and found to be 10 ppb or less. Here, the halogen content in the composition for forming piezoelectric film was measured by ion chromatography (IC500 manufactured by Yokogawa Electric Corp., the detection limit: 0.5 ppm).

### Preparation Example 2 of a High Purity Composition for Forming Piezoelectric Film: Composition for Forming PT Piezoelectric Film

The reagents as raw materials were subjected to removal of halogen components by means of the purification method described in Table 1, and then used to prepare the following composition. In an appropriate amount of 2-methoxyethanol, 0.105 mol of lead acetate trihydrate and 0.1 mol of tetraisopropoxy titanium were dispersed, and thus a lead titanate (PT) composition for forming piezoelectric film was prepared in which the content of lead titanate was 10 mass % as converted to the corresponding oxide. Hereinafter, this will be referred to as the composition B for use in formation of piezoelectric film. The halogen content in the composition B for use in formation of piezoelectric film was below the analytical detection limit; thus, the halogen content was derived from the halogen contents of the raw materials and found to be 10 ppb or less. Here, the halogen content in the composition for forming piezoelectric film was measured by ion chromatography (IC500 manufactured by Yokogawa Electric Corp., the detection limit: 0.5 ppm).

### Preparation Example 3 of a High Purity Composition for Forming Piezoelectric Film: Composition for Forming BTO Piezoelectric Film

The reagents as raw materials were subjected to removal of halogen components by means of the purification method described in Table 1, and then used to prepare the following composition. In 2-methoxyethanol, 0.05 mol of diethoxy barium and 0.05 mol of tetraisopropoxy titanium were dispersed, and thus a barium titanate (BTO) composition for forming piezoelectric film was prepared in which the content of barium titanate was 10 mass % as converted to the corresponding oxide. Hereinafter, this will be referred to as the composition C for use in formation of piezoelectric film. The halogen content in the composition C for use in formation of piezoelectric film was below the analytical detection limit; thus, the halogen content was derived from the halogen contents of the raw materials and found to be 10 ppb or less. Here, the halogen content in the composition for forming piezoelectric film was measured by ion chromatography (IC500 manufactured by Yokogawa Electric Corp., the detection limit: 0.5 ppm).

### Example 1

(Example of Film Formation of a Piezoelectric Film)

A PZT film and a PT film as lead based piezoelectric film and a BTO film as non-lead based piezoelectric film were produced on the surface of the Pt layer of a Pt/Ti/SiO₂/Si type multilayer substrate by use of the compositions A, B and C for use in formation of piezoelectric film. By use of a spin coater, a solution of any one of the above described compositions was applied onto the above described substrate at 3,000 rpm, then the substrate was dried at 150° C. for 10 minutes to remove the solvent and thus a dried coating layer was formed. The set of coating and drying operations was repeated 12 times. Finally, the whole substrate was subjected to heat treatment at 700° C. for one hour to crystallize and a 12 times coated film was obtained for each of the piezoelectric substances derived from the compositions A, B and C. Hereinafter, those films obtained from the compositions A, B and C for use in formation of piezoelectric film will be referred to as the A-12 film, B-12 film and C-12 film, respectively. The X-ray diffraction measurements of these piezoelectric films were conducted and the results obtained suggested that any of these films was composed of a single ferroelectric phase of a perovskite type crystal. The obtained piezoelectric films were investigated by ICP-MS and the elemental halogen contents thereof were found to be 10 ppb or less.

### Example 2

### Example-1 of Production of a Piezoelectric Element

A platinum film was formed by the sputtering method on the above described A-12 film. By using this platinum film and the platinum layer beneath the A-12 film as the electrodes, the dielectric constant of the A-12 film was measured to obtain the specific dielectric constant of 1,000 or more in the region from 10 to 10,000 Hz. Additionally, the hysteresis measurement was also conducted, and the results obtained included the observation of the hysteresis curve characteristic to a ferroelectric substance showing a reversed spontaneous polarization caused by the positive and negative variation of the magnitude of the external electric field, and the residual polarization Pr was found to be about 25 μC/cm². Consequently, the piezoelectric element produced in the present example was found to have excellent ferroelectricity. Additionally, the leak current was 2.0×10⁻¹⁰ A. The leak current was observed on an electrometer 6517A from Keithley, Inc. as the current when a DC voltage of 20 V was applied.

### Example 3

### Example-2 of Production of a Piezoelectric Element

A gold film was formed by the sputtering method on each of the above described B-12 film and C-12 film. By using this gold film and the platinum layer beneath either the B-12 film or the C-12 film as the electrodes as the case may be, the dielectric constants were measured for the B-12 and C-12 films; for any of the B-12 and C-12 films, the specific dielectric constant was 60 or more in the region from 10 to 10,000 Hz. Additionally, the hysteresis measurement was also conducted for the B-12 and C-12 films, and the results obtained included the observation of the hysteresis curves characteristic to a ferroelectric substance showing a reversed spontaneous polarization caused by the positive and negative variation of the magnitude of the external electric field. Consequently, the piezoelectric elements produced in the present example were found to have excellent ferroelectricity. Such hysteresis characteristics can be utilized for memory units; a plurality of any of the above described piezoelectric elements arranged in an array can form a memory unit when a voltage is applied to each element independently. Additionally, the leak currents were 1.7×10⁻¹⁰ A and 9×10⁻¹⁰ A in the B-12 and C-12 films, respectively.

### Example 4

### Comparative Example 1

### Example-1 of the Production of a Piezoelectric Element with Varied Halogen Content

Commercially available reagents as raw materials were used as obtained without performing the halogen removal treatment, and a composition for forming PZT piezoelectric film, having the same composition as that of the above described composition A for use in formation of piezoelectric film, was produced in a manner similar to that for the above described composition A for use in formation of piezoelectric film. By mixing this composition with appropriate amounts of the composition A for use in formation of piezoelectric film, the compositions different in halogen content were prepared, from which piezoelectric elements comprising the 12 layers of films were produced in a manner similar to those in Examples 1 and 2. For these films, the leak currents for the applied voltage of 20 V and the withstand voltages were measured. The results obtained are shown in the following table. The halogen contents in the compositions for use in formation of piezoelectric film were measures by ion chromatography (IC500 manufactured by Yokogawa Electric Corp., the detection limit: 0.5 ppm).

TABLE 2

| | Halogen | | Withstand |
|---|---|---|---|
| | content | Leak current | voltage |
| Example 4 | 1.0 ppm | 8.3 × 10⁻¹⁰ A | 9.0 × 10⁵ V/cm |
| | 3.0 ppm | 1.0 × 10⁻⁹ A | 9.0 × 10⁵ V/cm |
| | 10 ppm | 3.1 × 10⁻⁹ A | 8.5 × 10⁵ V/cm |
| Comparative | 20 ppm | 2.7 × 10⁻⁷ A | 3.0 × 10⁵ V/cm |
| example 1 | 50 ppm | 5.0 × 10⁻⁶ A | 1.5 × 10⁵ V/cm |

As can be seen from the table, the smaller is the halogen content in the coating solution, the smaller is the leak current; the smaller is the halogen content in the coating solution, the larger is the withstand voltage; and the withstand voltage is leveled off for the halogen content of 10 ppm or less, particularly, 3 ppm or less. An ICP-MS investigation of the obtained piezoelectric films revealed that the respective halogen contents were 1.0 ppm or less, 3.0 ppm or less, and 10 ppm or less.

Incidentally, the withstand voltages listed in Table 2 were the electric field values at which the elements were broken down while DC voltage was applied in an increasing manner to the piezoelectric elements by use of an electrometer 6517A from Keithley, Inc. The break down as referred to here means the condition where the leak current is larger than 9.0×10⁻³ A.

### Example 5

(Example of Production of a Piezoelectric Element for Use in an Ink Jet Recording Head)

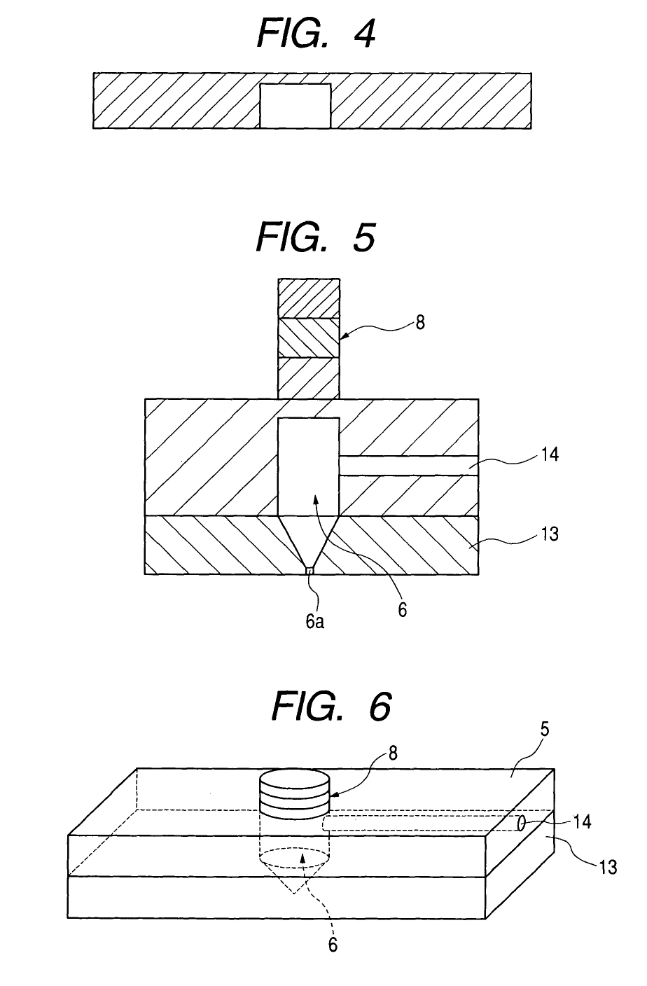

For the purpose of producing the piezoelectric elements for use in an ink jet recording head having a configuration as illustrated in FIGS. 3 and 4, a platinum electrode was deposited in 0.5 μm in thickness as the lower electrode on the surface of a zirconia substrate with a bored part on the backside thereof. The thickness of the vibrating part was 10 μm. The above described composition A for use in formation of piezoelectric film was applied onto the platinum electrode by use of a spin coater at 3,000 rpm, the coating layer was heated at 150° C. for 10 minutes to remove the solvent, and thus a dried coating layer was formed. The set of coating and drying operations was repeated 36 times. Finally the whole substrate was subjected to heat treatment at 700° C. for one hour for crystallization, and thus a 36 times coated PZT film was obtained. The thickness of the piezoelectric film thus obtained was about 2 μM. As a final step, a platinum layer was formed as the upper electrode on the piezoelectric film by the sputtering method, and thus a piezoelectric element of the present invention was produced. The leak current of the element was 3.4×10⁻¹⁰ A when a DC voltage of 20 V was applied.

The vibrational amplitude of the obtained piezoelectric element was measured using a laser Doppler meter when a voltage of 20 V was applied, confirming the vibrational amplitude of about 2.2 μm in the frequency range from 1 to 10 kHz. This displacement is the one sufficiently large for an ink jet recording head to jet ink. It has also been found that when the applied voltage is made smaller, the displacement becomes smaller, and the jetted ink amount can thereby be controlled.

### Example 6

### Comparative Example 2

### Example-2 of the Production of a Piezoelectric Element with Varied Halogen Content

Compositions with different halogen contents were prepared in a manner similar to those in Example 4 and Comparative Example 1, piezoelectric elements comprising a 36 layer film were produced in a manner similar to that in Example 5. The offset voltage of at maximum 20 V and 10 kHz was applied to these elements and the maximum vibrational amplitudes were measured by means of a laser Doppler meter, the results obtained being shown in the following table.

TABLE 3

| | | Maximum |
|---|---|---|
| | Halogen | vibrational |
| | content | amplitude |
| Example 6 | 1.0 ppm | 2.2 μm |
| | 3.0 ppm | 2.2 μm |
| | 10 ppm | 1.8 μm |
| Comparative | 20 ppm | 0.14 μm |
| example 2 | 50 ppm | 0 μm |
| | | (No vibration) |

As can be seen from the table, the smaller is the halogen content in the coating solution, the larger are the maximum vibrational amplitudes of the elements; the maximum vibrational amplitude is leveled off for the halogen content of 10 ppm or less, particularly 3 ppm or less.

### Example 7

(Example of Production of an Ink Jet Recording Head)

An ink jet recording head was produced by fixing to the piezoelectric element obtained in the above described Example 5 a nozzle plate 13 on which a nozzle 6a shown in FIGS. 5 and 6 was arranged and by arranging further an ink introduction path 14. By use of the ink jet recording head, the ink jetting experiment was conducted. The ink chamber was filled with ink by introducing ink through the ink introduction path to the above described, thus produced ink jet recording head. Then, the ink jet behavior was observed with a microscope while an AC voltage of 10 V and 1 to 20 kHz was applied between the upper electrode and lower electrode. Consequently, it was confirmed that the ink jet recording head was able to jet ink droplets following any of the different frequencies. Additionally, in a similar manner, an ink jet recording head provided with a plurality of ink nozzles was produced, for which the jetting of ink was also confirmed. Herewith, it has been found that the piezoelectric element of the present invention is useful as an ink jet recording head. As described above, description has been made with reference to Examples, but the present invention is not limited with respect to the composition ratios of the metal oxides and the types of the raw materials involved in the piezoelectric substance. Various film formation methods other than the sol-gel method can also be applicable.

What is claimed is:

1. A composition for forming a piezoelectric film comprising a dispersoid obtained from a metal compound, wherein the total content of the elemental halogens, halogen ions and halogen compounds contained in said composition is 10 ppm or less.

2. A composition for forming piezoelectric film according to claim 1, wherein said metal compound is an organometallic compound.

3. A composition for forming piezoelectric film according to claim 1, wherein the total content of the elemental halogens, halogen ions and halogen compounds contained in said composition is 3 ppm or less.

4. A composition for forming piezoelectric film according to claim 1, wherein at least titanium, zirconium and lead are contained as said metal.

5. A manufacturing method of piezoelectric film, comprising:
a process for forming a coating film by applying onto a substrate said composition for forming piezoelectric film in which the total content of the elemental halogens, halogen ions and halogen compounds contained in the composition comprising the dispersoid obtained from the metal compound is 10 ppm or less;
a process for drying said coating film; and
a process for obtaining a piezoelectric film by baking said dried coating film.

6. A piezoelectric element comprising a piezoelectric film sandwiched between a lower electrode and an upper electrode, wherein said piezoelectric film is produced by the method according to claim 5.

7. A piezoelectric element according to claim 6, wherein the total content of the elemental halogens, halogen ions and halogen compounds contained in said piezoelectric film is 10 ppm or less.

8. An ink jet recording head, comprising a pressure chamber communicating with an ink jet orifice, a vibrating plate arranged in a manner corresponding to said pressure chamber, a piezoelectric element according to claim 6 arranged in a manner corresponding to said vibrating plate, wherein the ink in said pressure chamber is jetted from said ink jet orifice owing to the volume change within said pressure chamber caused by said piezoelectric element.
